(19) United States
(12) Patent Application Publication
(10) Pub. No.: US 2010/0225432 A1
(43) Pub. Date: Sep. 9, 2010

(54) TRANSFORMER ASSEMBLY

(75) Inventors: Satan ZHAI, Dong-Guan City (CN); Y.L. XU, Dong-Guan City (CN)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: DELTA ELECTRONICS, INC., Taoyuan Hsien (TW)

(21) Appl. No.: 12/468,588

(22) Filed: May 19, 2009

(30) Foreign Application Priority Data
Mar. 3, 2009 (TW) 098203138

(51) Int. Cl. H01F 27/29

(52) U.S. Cl. 336/192

(57) ABSTRACT

A transformer assembly is provided. The transformer assembly comprises a plurality of transformers. The plurality of transformers is parallel and electrically connected. Each of the transformers has a base and a top, and the top is across from the base. The height from the base to the top is substantially less than 10 mm.

This application claims priority to Taiwan Patent Application No. 098203138 filed on Mar. 3, 2009, the disclosures of which is incorporated by reference herein in their entirety.

### CROSS-REFERENCES TO RELATED APPLICATIONS

Not applicable.

### BACKGROUND OF THE INVENTION

1. Field of the Invention

The present invention provides a transformer assembly, and more particularly, to a transformer assembly utilizing a plurality of low-profile transformers electrically connected in parallel to obtain a high output power.

2. Descriptions of the Related Art

With the development of science and technology, modern electronic products such as liquid crystal displays (LCDs), plasma display panels (PDPs) and DVD players gradually evolve towards low-profile designs to allow consumers to better utilize the restricted space in their homes and have such low-profile home appliances merged into the home environment. During the design of low-profile electronic products, smaller transformer dimensions that are required for low-profile design presents the greatest challenge mainly because the materials of the iron core and the like factors of transformers of the prior art are kept consistent, the output power of the transformers will be a direct proportion to the height of the transformers. Consequently, for electronic products requiring a higher output power, transformers thereof tend to have a larger height, making it impossible for electronic products to satisfy requirements of low-profile designs.

FIG. 1A illustrates the side view of a conventional transformer 100. For example, if an electronic product requires an output power of 200 W from a transformer thereof, the conventional transformer 100 should have a designed height H1 of about 18.8±1.0 mm. Even worse, some transformers 100 must have a height H1 of up to 30 mm in order to satisfy the required output power of 200 W. Similarly, FIG. 1B illustrates the top view of the conventional transformer 100. The transformer 100 has a length L1 of 50.0±1.0 mm and a width D1 of 44.5±1.0 mm. From these dimensional data in terms of the length, width and height and dimensional data of various electronic components (e.g., capacitors, transistors and resistors), those skilled in the art of electronic circuits will appreciate that the transformer 100 is larger in volume than the electronic components. Furthermore, in the design of low-profile electronic products, the main concern is mostly placed on the integration of circuits as far as possible, so the transformer 100 must also be designed to have a low profile to satisfy the demands for modern and future low-profile electronic products.

In view of this, it is highly desirable in this industry to provide a low-profile transformer to satisfy demands for modern or future low-profile electronic products.

### SUMMARY OF THE INVENTION

An objective of the present invention is to provide a transformer assembly. The transformer assembly, which is capable of transmitting a high output power, can be made with a low profile for installation in electronic products.

To this end, the transformer assembly comprises a plurality of transformers. Each of the transformers has at least one input pin and at least one output pin; and each of the transformers has a base and a top which is across from the base. A height from the base to the top is substantially less than 10 mm, and each of the transformers is parallel and electrically connected. The at least one input pin of each of the transformers is adapted to receive an input power, and then the at least one output pin transmits an output power. Each of the output power is collected to form an accumulative output power, with the accumulative output power not being equal to the input power.

The detailed technology and preferred embodiments implemented for the present invention are described in the following paragraphs accompanying the appended drawings for people skilled in this field to well appreciate the features of the claimed invention.

### BRIEF DESCRIPTION OF THE DRAWINGS

FIG. 1A illustrates the side view of a conventional transformer;

FIG. 1B illustrates the top view of the conventional transformer;

FIG. 2 illustrates a schematic view of the preferred embodiment of the present invention;

FIG. 3 illustrates an exploded view of the transformer of the present invention;

FIG. 4A illustrates the side view of the transformer of the present invention; and

FIG. 4B illustrates the top view of the transformer of the present invention.

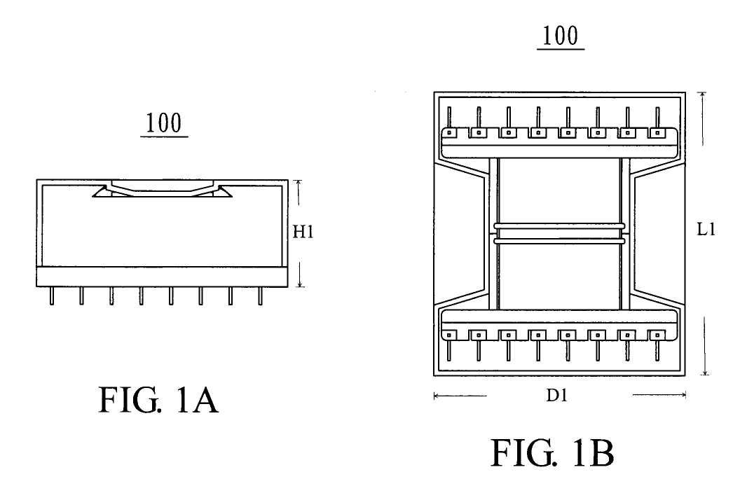

### DESCRIPTION OF THE PREFERRED EMBODIMENT

In the following description, the present invention will be explained with reference to embodiments thereof. However, these embodiments are not intended to limit this invention to any specific environment, applications or particular implementations described in these embodiments. Therefore, descriptions of these embodiments are only for purposes of illustration rather than to limit the present invention. In the following embodiments and the attached drawings, elements unrelated to the present invention are omitted from depiction.

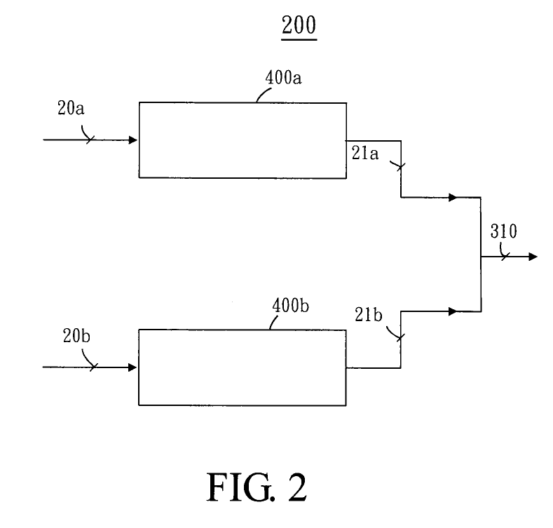

FIG. 2 illustrates a schematic view of a transformer assembly 200 according to the preferred embodiment of the present invention. The transformer assembly 200 comprises a plurality of transformers, each of which is adapted to receive an input power and then transmit an output power. In this embodiment, the transformers include a first transformer 400a and a second transformer 400b. The aforesaid number of the transformers is not intended to limit the present invention but only for purposes of illustration.

In particular, the first transformer 400a and the second transformer 400b are electrically connected in parallel. The first transformer 400a and the second transformer 400b are adapted to receive a first input power 20a and a second input power 20b included in the aforesaid input power respectively, and to transmit a first output power 21a and a second output power 21b included in the aforesaid output power respectively. Then, by electrically connecting the output terminals of the first transformer 400a and the second transformer 400b, the first output power 21a and the second output power 21b are collected to form an accumulative output power 310, which is not equal to one of the first input power 20a and the second input power 20b. It should be particularly noted that the first input power 20a and the second input power 20b may be either identical to or different from each other. For cases where the number of transformers is 3 or greater, the structures can be inferred from what is described above and thus will not be further described herein.

As an example, a certain electronic product demands an output power of 200 W from the transformer; that is, the transformer assembly 200 that adopts the present invention shall have an accumulative output power of 200 W. In this case, by having the first transformer 400a receive a first input power 20a of 50 W and then transform it into a first output power 21a of 100 W and having the second transformer 400b receive a second input power 20b of 50 W and then transform it into a second output power 21b of 100 W, an accumulative output power 310 of 200 W can be obtained by electrically collecting the first output power 21a and the second output power 21b through the electrical connections from the first transformer 400a and the second transformer 400b. Alternatively, by having the first transformer 400a receive the first input power 20a of 70 W and then transform it into a first output power 21a of 100 W and having the second transformer 400b receive a second input power 20b of 30 W and then transform it into a second output power 21b of 100 W, an accumulative output power 310 of 200 W can be obtained by collecting the first output power 21a and the second output power 21b. This example is only provided for purposes of illustration but not to limit the scope of the present invention, and those skilled in the art shall understand that alterations to this example will not depart from the scope of the present invention.

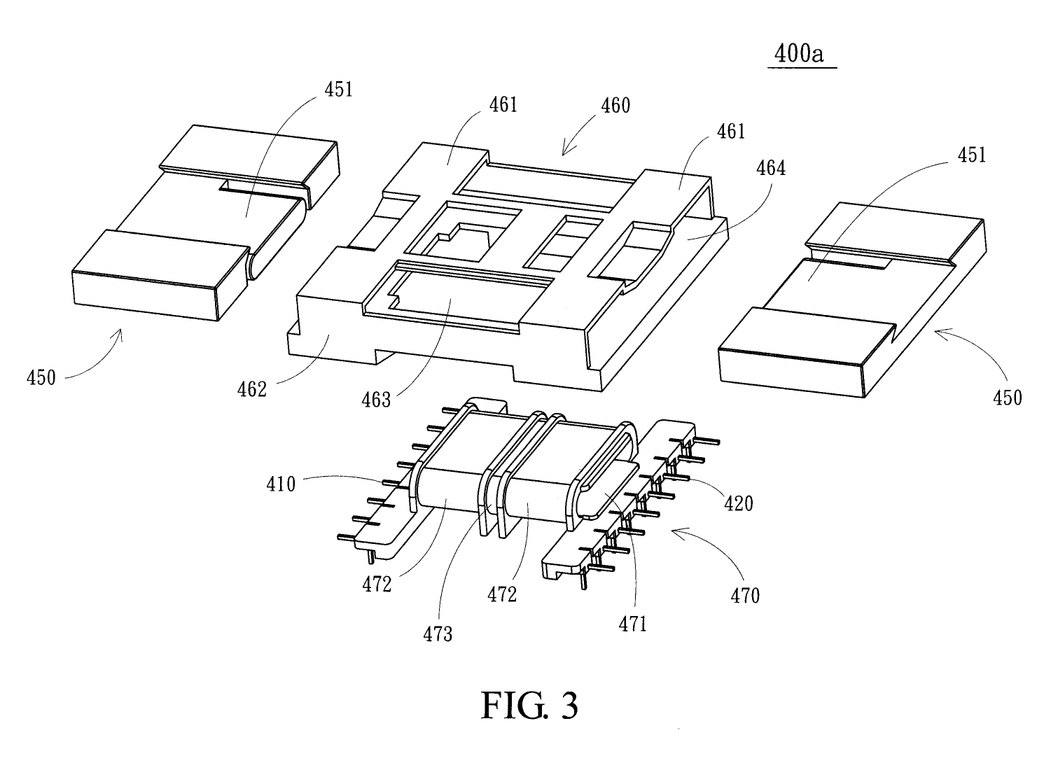

Next, structures of the first transformer 400a and the second transformer 400b will be detailed as follows. In reference to FIG. 3, an exploded view of the transformer of the present invention is shown therein. Because the first transformer 400a and the second transformer 400b are identical in terms of structures thereof, only the first transformer 400a will be described as a representative hereinbelow and the second transformer 400b is omitted from description.

The first transformer 400a comprises two embedded bodies 450, a mask 460 and a winding body 470. The two embedded bodies 450 and the winding body 470 are made of one of an iron and an iron alloy thereof. The two embedded bodies 450 have an embedded portion 451 respectively. The mask 460 has a protection portion 461 and a side wall 462, in which the side wall 462 is annularly disposed on the protection portion 461 to define a receiving space 463. The two corresponding ends of the side wall 462 have an opening 464 respectively. The winding body 470 is formed with an embedded hole 471 at the two corresponding ends thereof respectively, and is also formed with at least one input pin 410 and at least one output pin 420 at the other side thereof, with the at least one input pin 410 and the at least one output pin 420 are opposite each other. The at least one input pin 410 is adapted to receive the first input power 20a, while the at least one output pin 420 is adapted to transmit a first output power 21a. The receiving space 463 of the mask 460 is adapted to accommodate the winding body 470, and when the winding body 470 is covered by the mask 460 from above, the embedded portions 451 of the two embedded bodies 450 are exactly inserted respectively through the two openings 464 and the two embedded holes 471 such that relative positions among the two embedded bodies 450, the mask 460 and the winding body 470 are kept fixed and the protection portion 461 is adapted to join together with a side of the winding body 470.

The winding body 470 further comprises two winding portions 472 and a separating portion 473. The two winding portions 472 and the separating portion 473 are all disposed between the two embedded holes 471, and the separating portion 473 is further disposed between the two winding portions 472 to isolate the two winding portions 472 from each other. The two winding portions 472 are adapted to have a plurality of coils (not shown) wound thereon respectively.

In reference to FIG. 2 together, it should be emphasized that in practical implementation, the transformer of the present invention is connected as shown in FIG. 2. In other words, the at least one input pin of the first transformer 400a and at least one the input pin of the second transformer 400b receive the first input power 20a and the second input power 20b respectively, while the at least one output pin of the first transformer 400a and the at least one output pin of the second transformer 400b transmit the first output power 21a and the second output power 21b respectively. In the preferred embodiment of the present invention, the at least one input pin of each of the first and the second transformer 400a, 400b includes two input pins adapted to receive the first and the second input power 20a, 20b respectively, and the at least one output pin of each of the first and the second transformer 400a, 400b includes two output pins adapted to transmit the first and the second output power 21a, 21b respectively. However, neither the number of pins for receiving input power nor that of pins for transmitting output power is intended to limit the present invention.

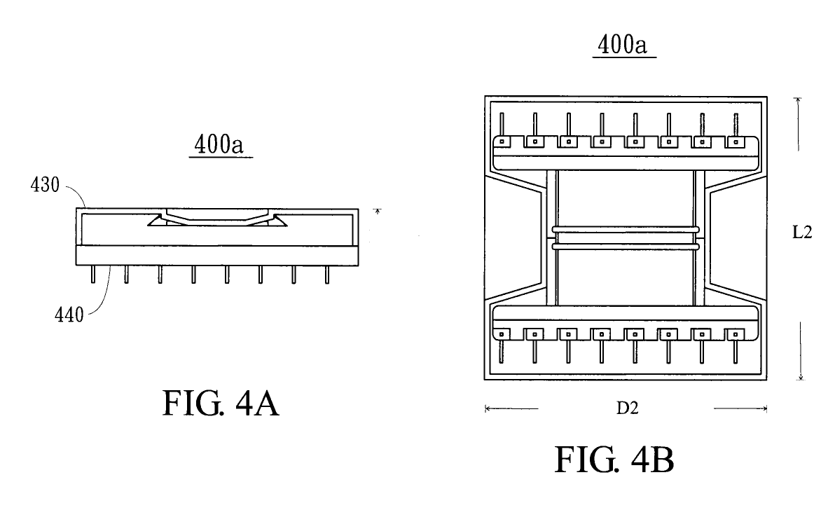

FIG. 4A illustrates a side view of a transformer of the present invention. Again, the first transformer 400a will be taken as an example and reference will be made to FIG. 2 together when necessary to make the objective of the present invention clearer. It should be particularly noted that FIG. 4A shows a complete transformer formed by assembling all associated elements of the first transformer 400a shown in FIG. 3. The first transformer 400a as assembled has a base 440 and a top 430 which is across from the base 440. The height from the base 440 to the top 430 is substantially less than 10 mm. Such a height solves the problem of a large height of conventional transformers, and by electrically connecting a plurality of transformers of the present invention in parallel, a high output power can still be obtained with the same operating frequency, materials and other factors as the conventional transformers. FIG. 4B shows a top view of the transformer of the present invention. Again, taking the first transformer 400a as an example, the length L2 thereof is 50.0±1.0 mm, while the width D2 thereof is 50.0±1.0 mm.

Therefore, by collecting the output power from a plurality of low-profile transformers, the transformer assembly of the present invention can still transmit a high output power for use in low-profile electronic products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transformer assembly comprising:
a plurality of transformers, each of the transformers having at least one input pin and at least one output pin, and each of the transformers having a base and a top, the top being across from the base, a height from the base to the top being substantially less than 10 mm, and each of the transformers being parallel and electrically connected;
wherein the at least one input pin of each of the transformers is adapted to receive an input power, and then the at least one output pin transmits an output power, and each of the output power is collected to form an accumulative output power, the accumulative output power is not equal to the input power.

2. The transformer assembly of claim 1, wherein each of the transformers comprises:
two embedded bodies, having an embedded portion respectively;
a mask, having a protection portion and a side wall, the side wall being annularly disposed on the protection portion to define a receiving space, two corresponding ends of the side wall having an opening respectively; and
a winding body, having two corresponding ends and the two corresponding ends respectively dispose an embedded hole, the receiving space of the mask being configured to accommodate the winding body, and the embedded portion of each of the two embedded bodies being inserted respectively through the openings and the embedded holes, such that the two embedded bodies, the mask and the winding body are fixed each other, wherein the protection portion is adapted to join together with a side of the winding body.

3. The transformer assembly of claim 2, wherein the winding body further comprises two winding portions and a separating portion, which are disposed between the two embedded holes, and the separating portion is disposed between the two winding portions to isolate the two winding portions from each other.

4. The transformer assembly of claim 3, wherein the two winding portions are configured to wind a plurality of coils respectively.

5. The transformer assembly of claim 3, wherein another side of the winding body has the at least one input pin and the at least one output pin, and the at least one input pin corresponds to the at least one output pin.

6. The transformer assembly of claim 3, wherein the two embedded bodies are made of one of an iron and an iron alloy thereof.

7. The transformer assembly of claim 3, wherein the winding bodies are made of one of an iron and an iron alloy thereof.

8. The transformer assembly of claim 1, wherein each input power received by the transformers is different.

9. The transformer assembly of claim 1, wherein each input power received by the plurality of the transformers is equal.
